(19) United States
(12) Patent Application Publication
(10) Pub. No.: US 2007/0170833 A1
(43) Pub. Date: Jul. 26, 2007

(54) Small compact fluorescent lamp

(76) Inventor: Gil Teva, Jerusalem (IL)

Correspondence Address: GIL TEVA, 20 MEKOR HALM, JERUSALEM, 93465, IL

(21) Appl. No.: 11/728,330

(22) Filed: Mar. 26, 2007

(30) Foreign Application Priority Data
Jan. 10, 2005 (IL) 166209
Nov. 2, 2005 (IL) PCT/IL05/01146

(51) Int. Cl. H01J 5/48

(52) U.S. Cl. 313/318.01

(57) ABSTRACT

A compact fluorescent lamp that has smaller size by employing plurality of low power, short and thin tubes, each connected to low power integrated electronic ballast instead of one wide and long tube.

### TECHNICAL FIELD

The present invention relates to compact fluorescent lamps and more particularly to lamps with electronic ballasts and plurality of tubes.

### BACKGROUND ART

A common compact fluorescent lamp includes a screw type socket, integrated electronic ballast and one fluorescent tube. The electronic ballast receives the line voltage from the plug and delivers high ignition voltage to the tube, and after the ignition, it supplies lower voltage to the tube.

U.S. Pat. No. 6,794,801 is common compact fluorescent lamp. U.S. Pat. No. 5,455,484, U.S. Pat. No. 4,520,436, U.S. Pat. No. 4,520,436, U.S. Pat. No. 5,552,666 and U.S. Pat. No. 4,862,035 include multiple tubes connected in series. U.S. Pat. No. 5,523,931 is a non-compact lamp with plural tubes. U.S. Pat. No. 5,325,024 is electrode-less RF fluorescent lamps.

U.S. Pat. No. 6,459,204 and U.S. Pat. No. 5,202,607 are 1+½ tube dimmable lamps. U.S. Pat. No. 5,202,607 is a plural tubes lamp with magnetic ballasts. U.S. Pat. No. 6,630,780 and JP59123157 have one gas discharge.

U.S. Pat. No. 5,309,062 CN1189683, JP2001015281, U.S. Pat. No. 5,367,229, U.S. Pat. No. 6,429,604, U.S. Pat. No. 4,438,372 are plural tubes without a screw type plug.

### DISCLOSURE OF THE INVENTION

The maximum ignition voltage that standard electronic ballast can supply is about 1000 volt.

A tube that ignites at that voltage has a working voltage of about 200 volt. The suitable tube current is about 10 milliampere per millimeter of the tube diameter. The suitable current of tubes with diameter of 5, 10 and 20 millimeter is 50, 100 and 200 milliampere, respectively.

The maximum power for 5, 10 and 20 millimeter tubes using standard electronic ballast is 10, 20 and 40 watt, respectively (200 volt*I).

The suitable power of a tube is proportional to its length. The length of 10, 20 and 40-watt tubes is 30, 60 and 120 centimeters, respectively.

Since the power depends only by the length, the power density of the tube increases as we decrease the diameter. The power density of 5, 10, and 20-millimeter tubes is 1.33, 0.33 and 0.08 watt per cubic centimeter, respectively.

By using four tubes of 5 millimeter and 10 watt instead of one tube of 20 millimeter and 40 watt, the size of the lamp becomes 16 times smaller. Smaller lamp has fewer raw materials, the storage and shipment is advantageous, and it is possible to install the lamp in small housing.

### BRIEF DESCRIPTION OF THE DRAWINGS

FIG. 1 is a pictorial view of the prior art compact fluorescent lamp with one wide tube connected to electronic ballast.

FIG. 2 is a pictorial view of the proposed high power lamp with thin tubes and electronic ballasts connected to each tube. There are only two tubes to make the drawing simple.

FIG. 3 is a pictorial view of the proposed high lumen lamp with fewer components by using a common circuit.

FIG. 4 is a pictorial view of some possible shapes of the proposed lamp.

### DETAILED DESCRIPTION OF THE INVENTION

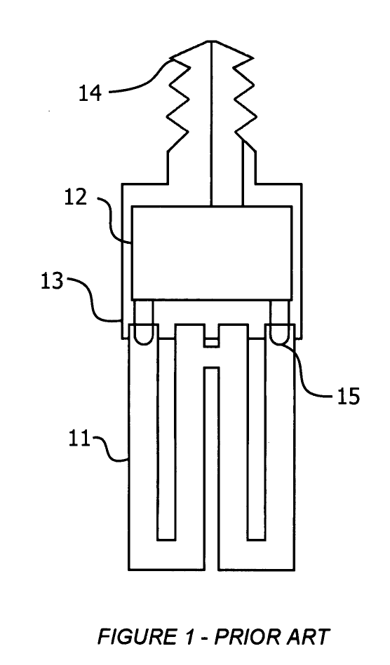

FIG. 1 is a pictorial view of a prior lamp that includes:

1. One fluorescent glass tube (11).

2. One electronic ballast (12).

3. Housing that is normally made of plastic (13).

4. Screw type plug (14).

5. Tube electrodes (15).

The plug (14) receives the line voltage and supplies it to the ballast (12). The ballast (12) supply regulated current to the electrodes (15). The current flows through the tube (11). The housing (13) holds together all the parts.

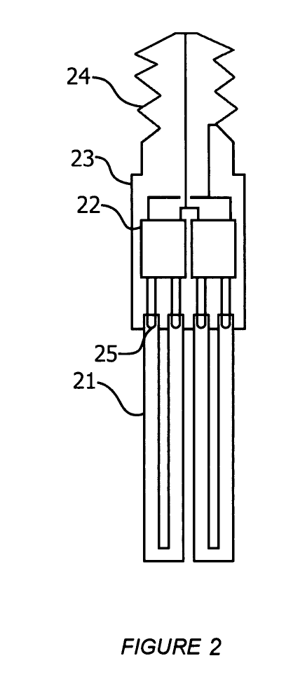

FIG. 2 is a pictorial view of a sample of the proposed lamp that includes:

1. Screw type plug (24).

2. Housing (23),

3. Two or more fluorescent glass tubes (21). The drawing shows only two in order to be simple, but the lamp can include more tubes without a specific limit.

4. Two electronic ballasts (22).

The plug (24) receives the line voltage and supplies it to the ballasts (22). The ballasts (22) supply regulated current to the electrodes (25). The current flows through the tubes (21). The housing (23) holds together all the parts.

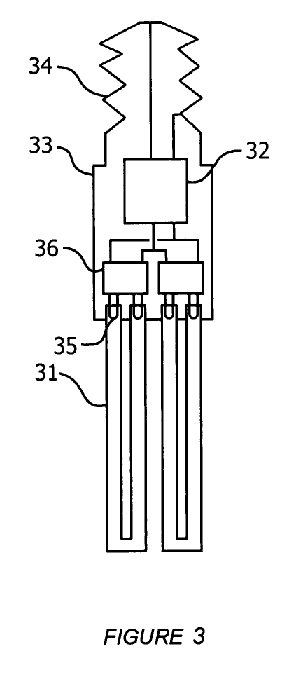

FIG. 3 is a pictorial view of a lamp with a common circuit.

This circuit reduces the total number of the electronic components of the ballasts. The common circuit (36) can include components that otherwise will be needed for each ballast, for example a fuse, rectifier, DC capacitor and oscillator.

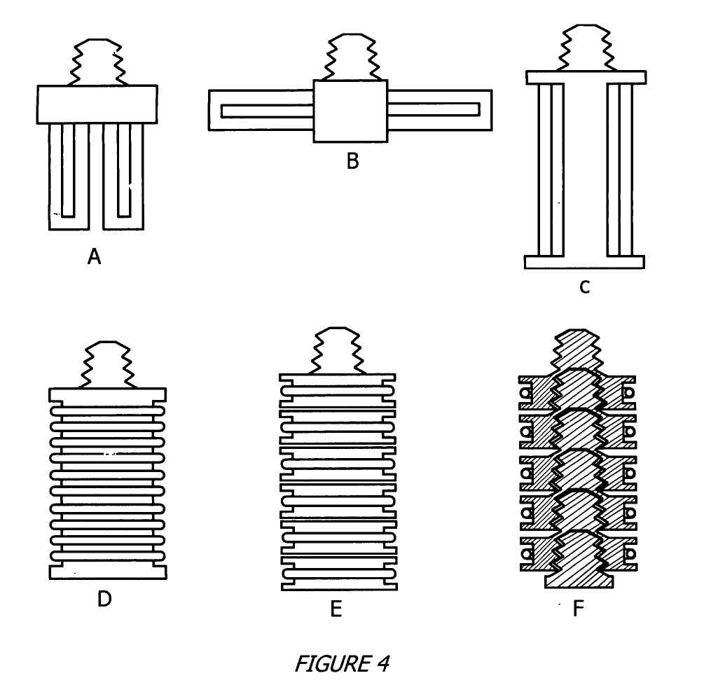

FIG. 4 is a pictorial view of some different shapes of the lamp.

In shape A the tubes are facing down like in a common compact fluorescent lamp.

In shape B the tubes are facing outside.

In shape C there is a plastic tube that contains the ballasts and the tubes are straight and parallel to it around the tube.

In shape D there is a plastic tube and the glass tubes are round and encircle it.

Shape E is as shape D but separated into plurality of individual sets. Each set includes housing, round tube that encircles it.

Shape F is as shape E but each set includes a screw type plug and a socket.

### BEST MODE FOR CARRYING OUT THE INVENTION

Many different lamps can be according to the new invention.

A 104-watt lamp with shape A was built. The lamp has eight “U” shape tubes. The diameter of each tube is 8 millimeter, the length is 15 centimeters and the power is 13 watt. The lamp diameter is 8 centimeters and the length is 20 centimeters.

### INDUSTRIAL APPLICABILITY

The possible power of each tube is 5-50 watt.

The possible length of each tube is 7-70 centimeters.

The possible number if the tubes can be from 2 to 200, depending on the power needed. It is possible to add means that will enable to choose how many fluorescent tubes will operate.

The lamp may include hot wire electrodes or cold cathode electrode.

The glass tubes and the electronic ballasts can be plug-in replaceable.

The plug can be small, standard or large mogul for HID retrofitting.

The plug can be bayonet type.

In order to decrease the lamp lifetime it is possible to decrease the current below 10 milliampere per millimeter of the diameter.

In order to increase the lamp power it is possible to increase the current above 10 milliampere per millimeter of the diameter.

In order to increase the lamp power it is possible to increase the current above 10 milliampere per millimeter of the diameter.

To achieve white color it is possible to use blue, green and red tubes, instead of white tubes. Each tube can have a shape of a “U”, two or more “U”, spiral, round, linear, flower shape, square or any other shape.

The tubes do not have to be in the same length and power.

The above description, illustrations and drawing do not limit its application to the specific examples that are given

1. A compact fluorescent lamp comprising of; 2 contact screw or bayonet plug, plurality of electronic ballasts, plurality of fluorescent tubes, each has a length of 7-70 centimeters, and power of 5-50 watt, and each tube has two hot or cold cathodes, and each electronic ballast is connected to the two cathodes of its appropriate tube, and the number of the tubes is any number, starting from 2 tubes having the same length, up to 200 tubes that are substantially but not absolutely the same length.

2. A lamp as in claim 1 with reduced number of electronic components, using an electronic circuit, that is connected between the AC plug and the electronic ballasts, that includes one or more of the following components: fuse, rectifying diodes, DC filtering capacitor and oscillator, and the use of each component eliminates the need of that component type in the electronic ballasts, for example using a circuit that has a fuse eliminates the need to put fuses in the electronic ballasts, or using a circuit with a fuse and rectifying diodes enables to use electronic ballasts without fuses and rectifying diodes, or using a circuit with a fuse, rectifying diodes and DC filtering capacitor enables to use electronic ballasts without fuses, rectifying diodes and DC filtering capacitors, or using a circuit with a fuse, rectifying diodes, DC filtering capacitor and oscillator enables to use electronic ballasts without fuses, rectifying diodes, DC filtering capacitors and oscillators, and in this last example the electronic ballasts can includes only coils.

3, A lamp as in claims 1 or 2, wherein each tube is connected to the electronic ballast with a plug that enables to replace it when it stops working.
